(19) United States
(12) Patent Application Publication
(10) Pub. No.: US 2003/0182168 A1
(43) Pub. Date: Sep. 25, 2003

(54) Systems and methods for virtual, real-time affinity diagramming collaboration by remotely distributed teams

(76) Inventor: Martha Lyons, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/104,448

(22) Filed: Mar. 22, 2002

(51) Int. Cl. G06F 17/60

(52) U.S. Cl. 705/8

(57) ABSTRACT

Virtual real-time affinity diagramming collaboration by a remotely distributed team of participants has posting a collaboration context on a virtual white board, visible to each of the participants in real time; generating, by each of the participants, virtual sticky notes for brainstorming ideas of that participant; moving the virtual sticky notes to the virtual white board; categorizing the virtual sticky notes into groups on the virtual white board; and labeling the groups to provide categories of the brainstorming ideas, expressed by the virtual sticky notes, in each of the groups.

### TECHNICAL FIELD

The present invention generally relates to collaboration and more specifically to systems and methods for virtual, real-time affinity diagramming collaboration by remotely distributed teams.

### BACKGROUND

A number of different collaborative thinking processes are used by facilitators in face-to-face group meeting settings. Affinity diagramming is a powerful technique for grouping and understanding information. In particular, affinity diagramming provides a process to identify and analyze issues. Although there are several variations of the technique, affinity diagramming, in general, is a brainstorming technique that generates ideas, or issues and problems in a specific domain and enables a group to categorize the ideas in a meaningful way. In a workshop environment, existing affinity diagramming techniques are used to help participants work together identifying, grouping and discussing issues. Affinity diagramming may also be used with a large amount of information.

In general, existing affinity diagramming techniques are used by groups that are trying to either categorize a large number of items or to brainstorm on ideas that individuals have worked on individually. This brainstorming is typically carried out after a context has been set by a facilitator. Affinity diagramming generally consists of placing related items together. If using pre-existing information, this information may be printed on labels or cards. In a group situation POST-IT “sticky” notes or the like are distributed to participants and the participants write one issue on each note. The participants are generally given some minutes for this activity, but are generally asked to stop when a large majority of participants have stopped.

Participants are gathered at a vertical surface suitable for application of sticky notes. For example, a window or a white marker board may be used. The participants are encouraged to place notes, sometimes one at a time, on the surface. As each note is placed, other participants may add similar notes in close proximity, starting to organize their stickies together. Then in combination with other participants, the group will start to reorganize the notes into categories. These categories are not normally predefined, but may be suggested by the facilitator. When all notes have been placed and grouped, the groups may be named.

Affinity diagramming is normally done face to face with large groups of people. However, in a face-to-face meeting, while people are working on their own stickies and focused downward on their own paper, they sometimes miss visual cues associated with body language and the like.

Existing guidelines teach that a facilitator must pay constant attention. Otherwise, the facilitator may loose touch with what is happening, and it may be difficult to regain an understanding of the data structure. Generally, it is difficult to ensure that all participants may contribute using existing affinity diagramming techniques. Additionally, an individual may dominate the process by, for example, taking control of positioning and moving the notes.

Traditionally, it is taught that affinity diagramming is best used when the resulting brainstorming and categorization is followed-up shortly after the activity is finished while rationalization for the resulting categorization is fresh on the participants' minds. For example, affinity diagramming of issues may lead to discussion of methods to address the issues.

There are some existing electronic tools that support various types of brainstorming. Traditionally, electronic assisted affinity diagramming is used for very small sets of data, using a word processor or spreadsheet program. However, existing methods teach that it is better to always work with paper. One existing stand alone software tool enables a single use, unretained affinity diagramming session. Other existing brainstorming processes are supported online including one known as Communispace. Communispace allows participants to brainstorm by writing down ideas in a sequential fashion, and perhaps voting, effectively providing a “me too on that.” Such a brainstorming technique is not affinity diagramming. Additionally, this online process is not focused on the real-time facilitation of affinity diagramming or similar process. SkyMark Corporation makes a project organization and optimization software tool known as PATHMAKER, see www.pathmaker.com, which seems to embody Ebert, U.S. Pat. No. 5,890,131. This tool allows an individual to organize ideas in a manner similar to affinity diagramming. However, no provision is made for distributed use by remotely located users.

Problematically, there is no existing electronic remote distributed tool that facilitates affinity diagramming in a real-time remote distributed meeting setting. A number of virtual meeting tools exist, for example Microsoft Net Meeting, Placeware Web Conferencing, Webex Meeting Center and the like. These programs are normally used for presentation of materials. Additionally, existing small group software allows sharing a white board or the like. Existing shared white boards for virtual meeting tools do not enable a strong facilitated process, as all participants typically have the same level of participation and rights. This situation is an inhibitor to success of movement of affinity diagramming to virtual meeting spaces. A key challenge is generally making virtual world experiences closely resemble real world experiences for group facilitators and consultants.

Problems arise in continuation and facilitation of brainstorming activities for remote meeting participants in that, travel restrictions may limit the ability of groups to meet and carry out such brainstorming. Regardless, in a face-to-face setting, affinity diagramming participants' memory of the exercise is often lost, because although the participants see how people move the notes around, the context for the discussion is typically lost after the activity is over. So, only the end result of the activity remains. Therefore, it is not possible for people who were not at the activity to understand the basis for the recommendations and the results of the affinity diagramming session. Additionally, those who do not participate do not have an opportunity to change the outcome of the affinity diagramming session and are limited to reviewing the outcome. Also, existing affinity diagramming techniques fail to provide a mechanism to elaborate on the results or process of a session.

### SUMMARY OF THE INVENTION

One embodiment of a method for virtual real-time affinity diagramming collaboration by a remotely distributed team of participants comprises posting a collaboration context on a virtual white board, visible to each of the participants in real time; generating, by each of the participants, virtual sticky notes for brainstorming ideas of that participant; moving the virtual sticky notes to the virtual white board; categorizing the virtual sticky notes into groups on the virtual white board; and labeling the groups to provide categories of the brainstorming ideas, expressed by the virtual sticky notes, in each of the groups. An embodiment of a system for virtual real-time affinity diagramming collaboration by remotely distributed participants comprises a server hosting a virtual white board, the server in data communication with the remotely distributed participants; a facilitator in data communication with the participants and the server; and a plurality of virtual sticky notes, generated by the participants in response to a topic posted to the white board by the facilitator, the virtual sticky notes moved into categories on the white board by the participants.

### BRIEF DESCRIPTION OF THE DRAWING

FIG. 1 is a flow chart of an embodiment providing virtual, real-time affinity diagramming collaboration by remotely distributed teams according to the present invention; and

FIG. 2 is a diagrammatic illustration of an embodiment providing virtual, real-time affinity diagramming collaboration by remotely distributed teams according to the present invention.

### DETAILED DESCRIPTION

The present invention is directed to systems and methods that enable groups of people, known as participants, to join together over a network such as the Internet, or similar electronic channel, in a remotely distributed real-time fashion employing personal computers, network workstations, or other similarly connected appliances, without face-to-face contact, to engage in brainstorming using affinity diagramming. Advantageously, embodiments of the present systems and methods provide an ability to record a distributed affinity diagramming session to replay the session and/or share the process experience with nonparticipants.

The present invention preferably provides a virtual affinity diagramming session, for remotely distributed participants, with a strong facilitation presence. Preferably, the facilitator starts the process, ends the process and is enabled to organize the process issues and organize electronic tagging of movement within the brainstorming process. The facilitator may answer online questions and facilitate a question and answer session before the brainstorming process begins. In accordance with one embodiment of the present invention, electronic support for affinity diagramming includes enablement of an identified facilitator to set a problem domain context by writing a topic label on a shared virtual white board. Then, if necessary, the facilitator may use a real-time communication mechanism (e.g. voice over IP, phone conference line, real-time chat, a textual description and/or the like) to explain the context of a problem domain to participants. After the facilitator sets the context and has answered the group's questions, the brainstorming process begins.

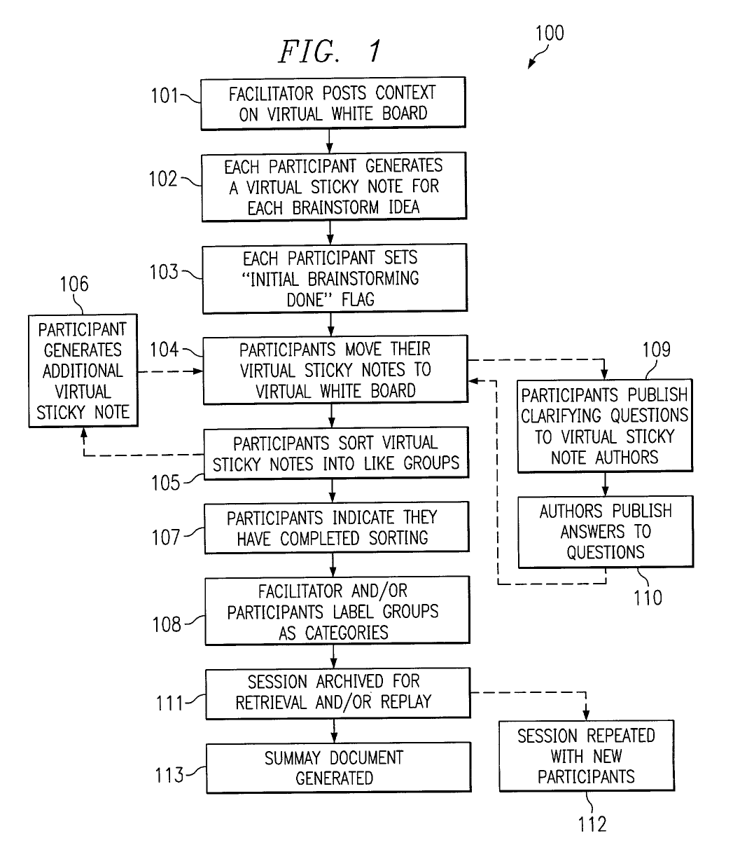

With attention directed to FIG. 1, after the context has been set at box 101, as described above, remotely distributed brainstorming process 100 preferably starts in accordance with the present invention. Each participant is preferably allowed time to generate “virtual sticky notes,” preferably at least one for each brainstorm idea at box 102. For example, each brainstorming idea or input into the present process by a participant may be entered onto one of these virtual notes. When the participants have completed preparation of the virtual sticky notes, each participant preferably sets a “done initial brainstorm” flag at box 103.

At this point, the facilitator preferably has a number of tools available by which the facilitator may either enable participants to, as they are finished, “come up” to a virtual white board that is visible to all the participants and place their virtual stickies, or to keep the participants waiting until everyone is done. Thereby, the facilitator preferably has a capability to personalize the experience for the particular brainstorming session. Participants move their virtual stickies to the electronic white board at 104 and start to organize their own ideas at box 105. Alternatively, as the participants post their virtual stickies to the virtual white board at box 104, all of the participants begin to collectively sort the ideas into groups at box 105. This organization or sorting is preferably accomplished by moving “like” virtual stickies together, preferably by participants dragging and dropping the stickies. Preferably, at any point a participant may generate more idea stickies such as shown at box 106 and place them on the board at box 104. According to one embodiment of the present invention, any participant may move a sticky generated by another participant to another position or duplicate virtual stickies into multiple groups. Alternatively, the facilitator may also move virtual stickies and/or restrict movement of virtual stickies.

As there may be a number of people participating at the same time in this sorting process, a mechanism is preferably employed to ensure that there is some consistency, preferably so that two participants are not organizing the same idea at the same time. To that end, one embodiment of the present invention provides that while a virtual sticky is being moved no one else may handle that sticky virtually. This ensures that two people are not able to manipulate the same note at the same time.

The organization process preferably continues until all participants express that they have given their input and/or express that they have moved all notes they wish to move. Participants may specify when they have completed sorting at box 107. Preferably, the facilitator or alternatively, any participant, may label a group with an appropriate heading or category. This may be done at any point during the session, but may preferably be delayed until sorting is completed as shown at box 108.

Preferably, the facilitator monitors the process and sees what is happening at any given time. Additionally, the facilitator may playback any movement and/or decide when to stop the process. At which time, the facilitator may decide to solicit feedback from participants. The present process is facilitated with remote tools, and at the end of the process discussion may continue in a virtual meeting setting, whether it be an electronic chat or the like, or over the phone.

During the brainstorm sorting process, the facilitator and all participants are preferably able to see which participants are active in which stages of the affinity diagramming process. This may be accomplished by tags indicating the participant moving a virtual sticky. Additionally, the participants are preferably able to see who generated each virtual sticky. One embodiment of the present invention allows a participant to mouse over a virtual sticky to initiate a pop-up window or the like which indicates which participant created a virtual sticky and when. Preferably, the facilitator and participants are able to see a history of who moved a virtual sticky and are able to replay the affinity process from a visual perspective, including placement and movement of virtual stickies on the virtual white board.

Preferably, participants are able to see from a labeled grouping which participants contributed virtual stickies under that heading. Participants are preferably able to direct clarifying questions regarding a virtual sticky note to the author of that sticky via a question and answer facility at box 109. The questions at box 109 and answers at box 110 are preferably globally published to the entire group during the brainstorming process.

Once the activity is ended, the results as well as the session itself may be archived at box 111 for future retrieval of the results and/or replay of the activity at box 112. The ability to playback the process enables a participant or somebody who was not observing and/or participating to see the history of an affinity diagramming session and thereby obtain a perspective of how the final result was formed. Preferably, the playback has rich content associated with the context to enable one to see who generated the initial virtual stickies, who moved them, who generated additional categories and in what order virtual stickies were moved. Preferably, time and identification stamps on the stickies enable understanding of who generated an idea first and who were the most active participants in the process. Conversely, this enables identification of those who were only observers and not participants. Therefore, one reviewing the context may understand who was participating. This may facilitate understanding the decision-making process. For example, if there were a number of people from different divisions or different companies taking part in a session, and one reviewing the session saw that “Company A” and “Company B” were very active in the results, but “Company C” and “Company D” were not, then the reviewer might draw some conclusion about the results of the meeting by identifying the “stakeholders” and what their motivation and future support or participation interest might be. Additionally, a document or other output summarizing the results may be generated with pertinent information at box 113.

At the end of the virtual affinity diagramming session, the facilitator may, in accordance with the present invention, gather feedback on the process, and the results, through an electronic voting process. In addition, during the exercise itself, participants may express a need for help, or concern over the process by using the aforementioned real-time communication mechanism to connect them with the facilitator, and/or other participants. This communication mechanism may be enabled as an unstructured dialogue or by enabling the participants to pick from a palette of available “tags” which may be used to express their “mood” related to the activity.

Preferably, the process may be continued at box 112 with a different group that virtually meets to continue steps 102 through 108 above. This follow-up session may be separately archived at step 111. This enables new team members and groups to be included where appropriate and indicated by the initial session.

Advantages of the present invention include elimination of the face-to-face participation requirement, which may be accomplished in accordance with the present invention in a remote manner while maintaining many of the visual cues available in a face-to-face meeting. The present invention enables brainstorming by remote teams without requiring travel. The playback and archival mechanisms enable people who did not participate or experience the process as an observer, to see the context of the affinity diagramming exercise. The present invention also enables retrospective comment on participation and the results. The aforementioned archival capabilities enable new team members and groups to be included where appropriate. In traditional face-to-face affinity exercises, the working framework surrounding placement of stickies is normally lost.

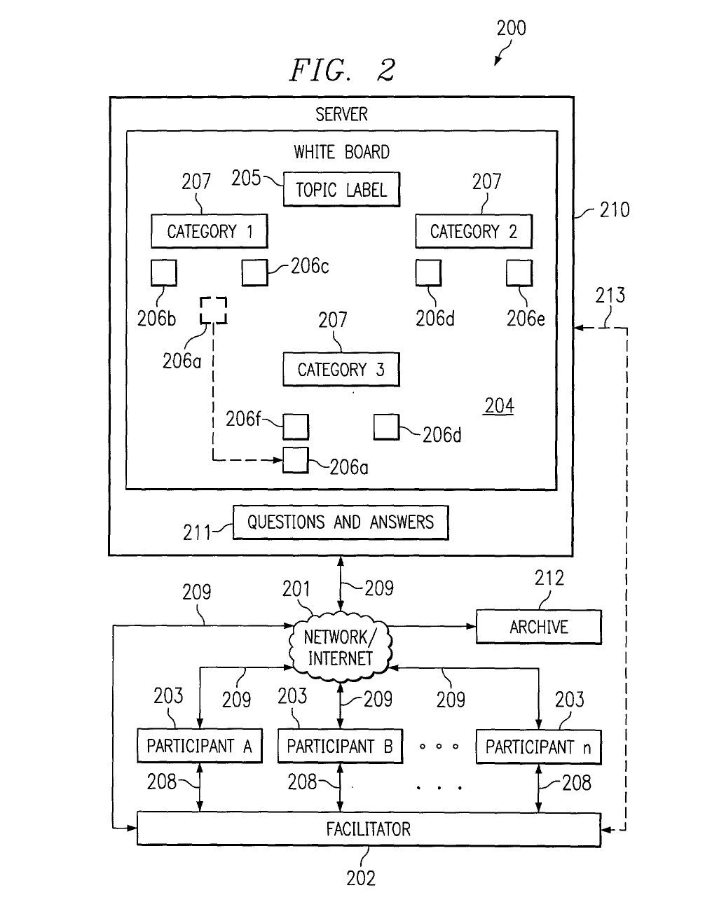

Turning to FIG. 2, an embodiment of system 200 to implement the present methods for virtual, real-time affinity diagramming collaboration by remotely distributed teams is illustrated. Preferably, one channel of activity, 209, which employs the Internet or other network (201) to enable the present brainstorming process. Facilitator 202 and participants 203 may also have alternate channel of communication 208, which may be the telephone or some other communication capability enabling either one-on-one communication or conferencing. Preferably, verbal communication via link 208 is used by facilitator 202 at least at the beginning and the end of a session to encourage verbal feedback, or to clarify process issues before going forward. Alternatively, only main channel of communication 209 might be used for all communication, particularly during the brainstorming process. Preferably, during steps 102 through 108 above, limited communication outside of main channel of activity 209 is carried out in a desire to record the events that lead up to the brainstorming results. So, after providing a verbal and/or text based context setting, facilitator 202 preferably posts the topic of the brainstorming session on shared white board 204, using main channel 209 and if facilitator 202 so desires, the facilitator may post a number of suggested categories 207. Facilitator 202 preferably has control over when the brainstorming process begins, and when the brainstorming process ends.

Once the brainstorming process begins, each participant 203 preferably has access to a palate of virtual stickies (206) where they may each write down an idea, one per sticky. Per step 105 above, participants sort stickies on universally visible virtual white board 204. By way of example, virtual stickies 206b and 206c are shown under Category 1 while stickies 206d and 206e are shown under Category 2, and virtual stickies 206a, 206f and 206d under Category 3. Virtual sticky 206a is shown as having been moved from under Category 1 to Category 3. Alternatively, a copy function, where a virtual sticky may be copied by a participant to apply the sticky to more than one category may be used. Sticky 206d has been copied so that it appears under both Categories 2 and 3. Alternatively, participants may agree to an idea expressed by a sticky by clicking a “me too” setting or the like. Additionally, dissenting opinions about where a sticky should come to rest may be noted and captured as well. As movement of stickies starts to slow down, facilitator 202 may decide when to stop the process, or may ask verbally over channel 208 or electronically over channel 209 if all participants are finished and get feedback from the group to see if people are still working.

The feedback, questions and answers during the session, questions and answers regarding what someone else has written on a sticky, or the like are preferably made through an electronic question and answer feature 211 over link 209. This enables all the other participants to see the same answers, and facilitates use by future participants, employing the aforementioned replay, who would benefit from seeing such context information. Alternatively or additionally, as one skilled in the art would readily realize, voice communications via link 208 may be recorded and/or transcribed for use in conjunction with, or as a part of, archive 212.

Server 210 hosting white board 204 also preferably hosts question and answer feature 211. Facilitator 202 may be independently interfaced with server 210 as shown by alternative link 213 or may access sever 210 via network/Internet 201 the same as participants 203.

When the session is completed, facilitator 202 may stop and designate that the process is over. Group comments may be generated about the session or the outcome. This is preferably carried out primarily over link 209. Alternatively, if carried out verbally over secondary connection 208, the facilitator may include a background summary of the comments for the benefit of those who playback archive 212 of the session. Preferably, archival and replay function 212 enables all viewers to get the same context following the meeting. This function also enables future participants or groups, such as focus groups, to start, not from a blank slate, but from where another group left off. Preferably, archive 212 will track deleted stickies, categories and the like. Archive 212 may be maintained by white board hosting server 210 or independently as shown in FIG. 2.

What is claimed is:

1. A method for virtual real-time affinity diagramming collaboration by a remotely distributed team of participants, said method comprising:
posting a collaboration context on a virtual white board, visible in real time to each of said participants;
generating, by each of said participants, virtual sticky notes for brainstorming ideas of that participant related to said context;
moving said virtual sticky notes to said virtual white board;
categorizing said virtual sticky notes into groups on said virtual white board; and
labeling said groups to provide categories of said brainstorming ideas, expressed by said virtual sticky notes, in each of said groups.

2. The method of claim 1 wherein said virtual white board is hosted on a server.

3. The method of claim 1 wherein a facilitator posts said context on said white board.

4. The method of claim 1 further comprising indicating, by each of said participants, that said participant has completed initial brainstorming.

5. The method of claim 1 wherein said categorizing of each of said virtual sticky notes is carried out, at least initially, by said participant that generated each of said virtual sticky notes.

6. The method of claim 1 wherein said categorizing is carried out by a plurality of said participants.

7. The method of claim 1 further comprising recording an archive of said posting, generating, moving, categorizing and labeling.

8. The method of claim 7 further comprising replaying said archive.

9. The method of claim 7 further comprising repeating said generating, moving, categorizing and labeling by at least one of said participants using said archive.

10. The method of claim 7 further comprising repeating said generating, moving, categorizing and labeling by at least one party other than said participants using said archive.

11. The method of claim 1 further comprising summarizing said posting, generating, moving, categorizing and labeling by said facilitator.

12. The method of claim 1 wherein said generating is repeated after at least one of said virtual sticky notes is moved to said white board.

13. The method of claim 1 further comprising indicating, by said participants, that said categorizing is complete.

14. The method of claim 13 wherein said indicating is in response to an inquiry by said facilitator.

15. The method of claim 1 further comprising publishing by at least one of said participants to all of said participants, a clarifying question directed to one of said participants that generated one of said virtual sticky notes.

16. The method of claim 15 further comprising publishing to all of said participants an answer to said question by said participant that generated said one virtual sticky note.

17. A system for providing real-time affinity diagramming collaboration for a team of remotely distributed participants, said system comprising:
means for hosting a virtual white board;
means for networking said participants and a collaboration facilitator with said hosting means;
means for establishing a communication link between said facilitator and said participants;
means for displaying, on said white board, virtual sticky notes generated by said participants to express at least one idea;
means for enabling said participants to move said virtual sticky notes on said white board into categories;
means for enabling labeling of said categories; and
means for recording said collaboration for later interactive replay by at least one other participant.

18. A system for virtual real-time affinity diagramming collaboration by remotely distributed participants, said system comprising:
a server hosting a virtual white board, said server in data communication with said remotely distributed participants;
a facilitator in data communication with said participants and said server;
a plurality of virtual sticky notes, generated by said participants in response to a topic posted to said white board by said facilitator, said virtual sticky notes moved into categories on said white board by said participants.

19. The system of claim 18 further comprising an archive of said generation of said virtual sticky notes and categorization of said virtual sticky notes.

20. The system of claim 18 further comprising a second communication channel between said participants and said facilitator.
